(19) United States
(12) Patent Application Publication
(10) Pub. No.: US 2014/0042007 A1
(43) Pub. Date: Feb. 13, 2014

(54) CONTACT STRUCTURE

(71) Applicant: Yazaki Corporation, Tokyo (JP)

(72) Inventor: Manabu SAKAI, Makinohara-shi (JP)

(73) Assignee: Yazaki Corporation, Tokyo (JP)

(21) Appl. No.: 14/060,039

(22) Filed: Oct. 22, 2013

Related U.S. Application Data
(63) Continuation of application No. PCT/JP2012/063407, filed on May 18, 2012.

(30) Foreign Application Priority Data
May 18, 2011 (JP) 2011-111363

(51) Int. Cl. H01H 1/44

(52) U.S. Cl. CPC H01H 1/44
USPC 200/556

(57) ABSTRACT

A contact structure includes a busbar which is provided with a plurality of fixed contacts and a contact which includes a body part, conductive parts and a fixing part. The conductive parts are extended from the body part. The fixing part is extended from the body part so as to urge the conductive parts toward the fixed contacts. Each of the fixed contacts respectively includes a concave portion configured to come into contact with the conductive parts, and convex portions formed at both sides of the concave portion. The fixing part slides between a concave portion and convex portions which are formed in the supportive engaging part. The conductive parts come into contact with the concave portions of the fixed contacts in a state where the fixing part is positioned in the concave portion of the supportive engaging part.

### CROSS REFERENCE TO RELATED APPLICATIONS

This application is a continuation of PCT application No. PCT/JP2012/063407, which was filed on May 18, 2012 based on Japanese Patent Application (No. 2011-111363) filed on May 18, 2011, the contents of which are incorporated herein by reference.

### BACKGROUND OF THE INVENTION

1. Field of the Invention

The present invention is related to a contact structure between a contact and a busbar.

2. Description of the Related Art

In an interior illuminating light for a vehicle disclosed in the below mentioned PTL 1, when a switch lever provided in a function part is tilted by operating a switch knob, a fixed contact at a side of the function part which is connected to a contact at a side of the switch lever is switched, and thus, the interior illuminating light for a vehicle is turned on or off. Heretofore, in a contact structure of this type, the contact has been connected to the fixed contact by engaging a pair of conductive parts provided on the contact with conductive engaging parts provided on the fixed contact in the function part.

### CITATION LIST

[Patent Literature]

[PTL 1] JP-A-2005-329884

### SUMMARY OF THE INVENTION

In the contact structure of this type, because the contact is supported by the two conductive parts which are used for connection with the fixed contact, it is necessary to arrange two fixed contacts at both sides of the contact. Besides, a posture of the contact is not stabilized.

It is therefore one advantageous aspect of the present invention to provide a contact structure in which a posture of the contact is stabilized.

According to one advantage of the invention, there is provided a contact structure comprising:

a busbar, fixed to a housing, and provided with a plurality of fixed contacts, and

a contact, configured to be electrically connected to the fixed contacts, and including:
a body part fixed to a switch knob;
two conductive parts extended from the body part and configured to be brought into elastic contact with the fixed contacts; and
a fixing part, extended from the body part with space from respective end portions of the conductive parts, and configured to be brought into contact with a supportive engaging part of the housing so as to urge the conductive parts toward the fixed contacts,

wherein each of the fixed contacts respectively includes a concave portion configured to come into contact with the conductive parts, and convex portions formed at both sides of the concave portion,

wherein the fixed contacts are fixed in an electrically isolated manner from each other, and positioned only at a side of the conductive parts,

wherein the fixing part slides between a concave portion and convex portions which are formed in the supportive engaging part, and

wherein the conductive parts come into contact with the concave portions of the fixed contacts in a state where the fixing part is positioned in the concave portion of the supportive engaging part.

The fixing part may be positioned between the two conductive parts.

A sum of urging forces of the conductive parts to come into contact with the fixed contacts may be equal to an urging force of the fixing part to come into contact with the supportive engaging part.

According to the invention, the contact is supported by the conductive parts and the fixing part, and there is no necessity of providing the fixed contacts at a side of the fixing part. Therefore, a space for installing the busbar can be reduced. Besides, it is possible to change switch feeling and a touch of click on occasion of operating the contact, only by altering the concave-convex shape of the fixed contacts and the supportive engaging part.

According to the invention, a distortion will not occur in the contact, and therefore, switching operation of the fixed contacts can be stabilized.

According to the invention, contacts of the conductive parts and the fixing part can be performed in a well balanced manner.

### BRIEF DESCRIPTION OF THE DRAWINGS

FIG. 1 is a perspective view showing a surface of an illuminating device in an embodiment according to the invention.

FIG. 2 is a perspective view showing a back face of the illuminating device as shown in FIG. 1.

FIG. 3 is a perspective view showing a back face of a switch knob as shown in FIG. 1.

FIG. 4 is a perspective view of a contact as shown in FIG. 3.

FIG. 5 is a bottom face view of a housing as shown in FIG. 1.

FIG. 6 is a bottom face view of the housing as shown in FIG. 1.

FIG. 7 is a bottom face view of the housing as shown in FIG. 1.

FIG. 8 is a bottom face view of the housing as shown in FIG. 1.

### DETAILED DESCRIPTION OF THE EXEMPLARY EMBODIMENTS

An embodiment according to the invention will be described, referring to the drawings.

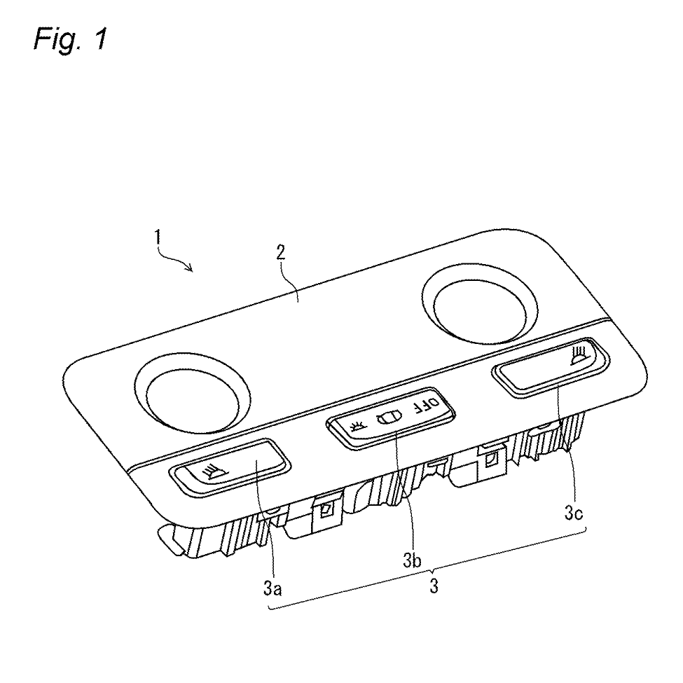

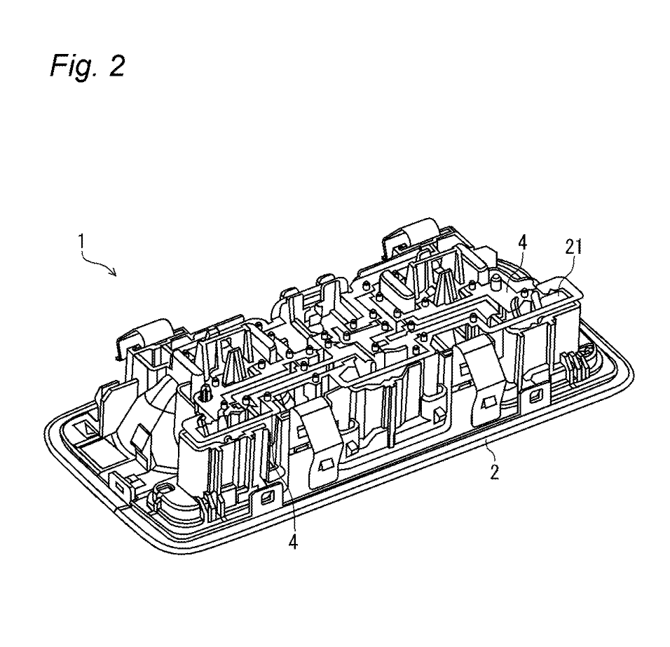

As shown in FIG. 1, an illuminating device 1 includes switch knobs 3 which are provided on a surface of a housing 2. Each of the switch knobs 3 are indicated by 3a to 3c in the drawing. A busbar 4 for electrical connection is fixed to a back face of the housing 2, as shown in FIG. 2. Moreover, an accommodating hole 21 is open to a back side of the housing 2.

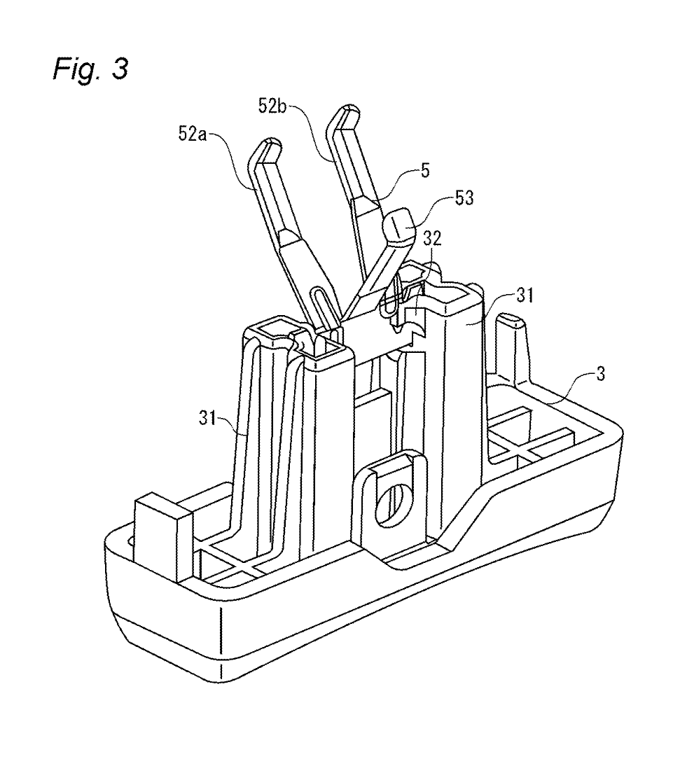

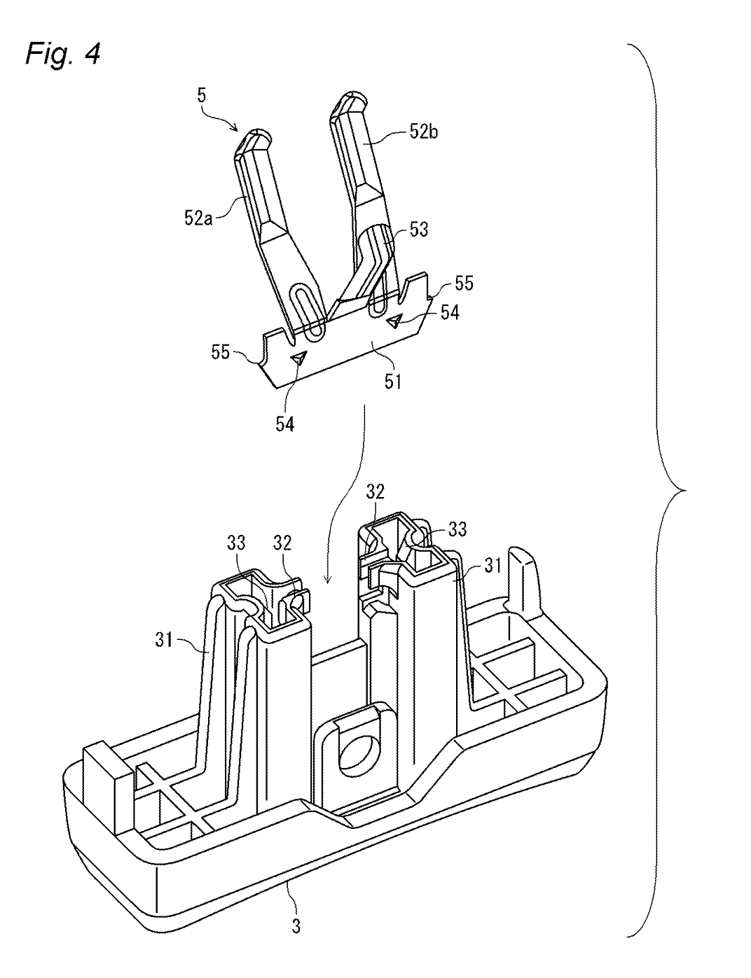

The switch knobs 3 are held so as to swing in a longitudinal direction of the housing 2. In each of the switch knobs 3, a pair of mounting parts 31 are extended from a back side of the switch knob 3, as shown in FIG. 3, and a contact 5 is fixed to the mounting parts 31. The mounting parts 31 are juxtaposed in a longitudinal direction of the switch knob 3. As shown in FIG. 4, engaging portions 32 are formed in the respective mounting parts 31, by providing slits on one side walls thereof which are directed inward in a longitudinal direction of the mounting parts 31. Engaging projections 33 are formed on inner faces of the other side walls of the mounting parts 31 which are directed outward in the longitudinal direction, at respective positions opposed to the slits.

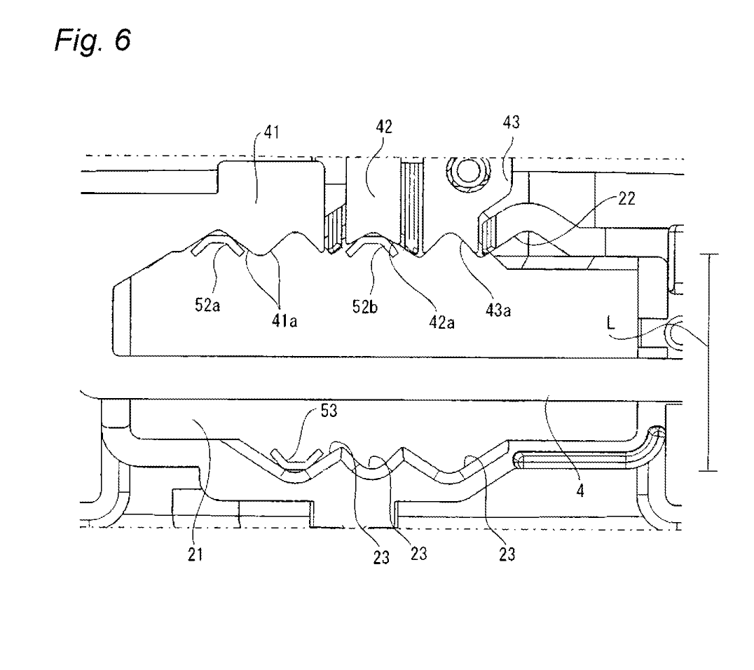

The contact 5 includes two conductive parts 52a, 52b and a single fixing part 53 which are extended from a body part 51. The body part 51 has locking projections 54 which are provided in opposite end parts in a longitudinal direction thereof, and locking pieces 55 which are provided on opposite end faces in the longitudinal direction. The conductive parts 52a, 52b are extended to one principal face side of the body part 51, and then, bent to the other principal face side, each having a U-shaped cross section in a distal end part thereof. The fixing part 53 is extended to the other principal face side of the body part 51, and then, bent to the one principal face side, having a U-shaped cross section in a distal end part thereof. A distance between the distal end of the fixing part 53 and the distal ends of the conductive parts 52a, 52b is made larger than a distance L between one edge and the other edge of the accommodating hole 21 (See FIG. 6). The contact 5 is fixed to the mounting parts 31, by locking the locking projections 54 to the engaging portions 32, and by locking the locking pieces 55 to the locking projections 33.

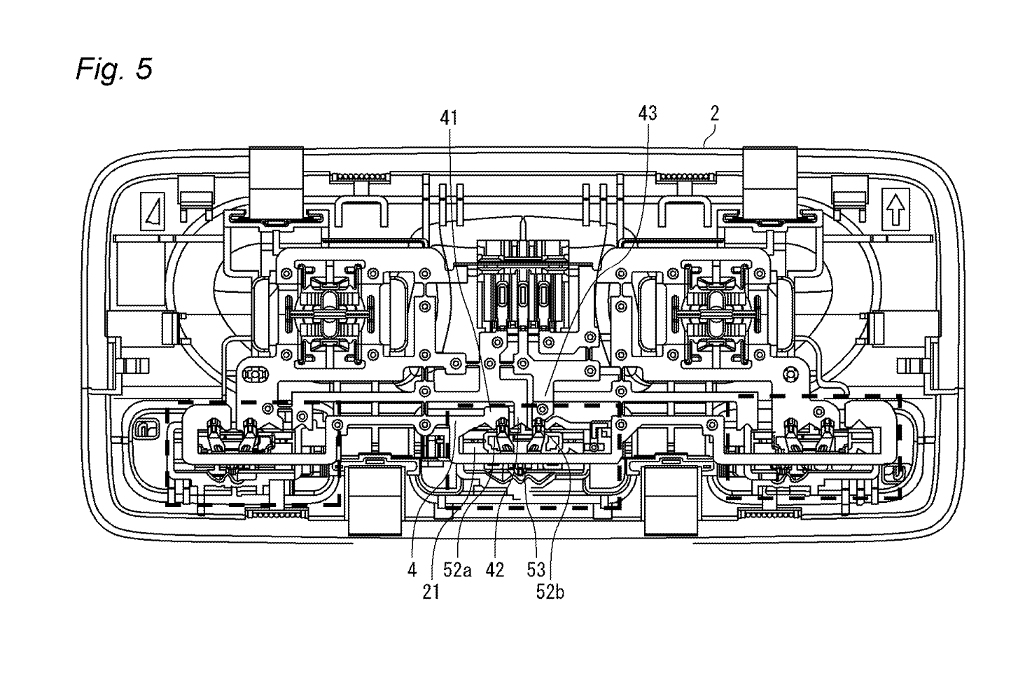

The contact 5 is contained in the accommodating hole 21, as shown in FIG. 5, by flexing the conductive parts 52a, 52b and the fixing part 53 inwardly into the accommodating hole 21. The conductive parts 52a, 52b and the fixing part 53 are positioned in an opening at a back side of the accommodating hole 21.

FIG. 6 is a bottom face view of the housing 2, in which a region surrounding the opening at the back side of the accommodating hole 21 which is positioned in the center is shown in an enlarged scale. As shown in FIG. 6, an interruptive engaging part 22 is provided at the one edge of the accommodating hole 21. Moreover, three supportive engaging parts 23 are provided at the other edge of the accommodating hole 21. Both the interruptive engaging part 22 and the supportive engaging parts 23 have a concave-convex shape each having convex portions at both sides of a concave portion.

Fixed contacts 41 to 43 of the busbar 4 are arranged on the one edge of the accommodating hole 21. Conductive engaging parts 41a to 43a of the fixed contacts 41 to 43 have a concave-convex shape each having convex portions at both sides of a concave portion, and are arranged along the one edge of the accommodating hole 21, in parallel with the interruptive engaging part 22. The conductive engaging parts 41a to 43a are fixed in a state electrically isolated from one another.

The conductive parts 52a, 52b are in elastic contact with either of the conductive engaging parts 41a to 43a, and the interruptive engaging part 22 which are arranged along the one edge of the accommodating hole 21. Moreover, the fixing part 53 is in elastic contact with either of the three supportive engaging parts 23 which are arranged along the other edge of the accommodating hole 21. A sum of urging forces of the two conductive parts 52a, 52b which are in contact with the busbar 4 is equal to an urging force of the fixing part 53 which is in contact with the housing 2.

When the switch knob 3 is tilted in the longitudinal direction by a tilting operation, the conductive parts 52a, 52b and the fixing part 53 move in a direction opposite to the switch knob 3. Accordingly, the conductive parts 52a, 52b and the fixing part 53 slide in elastic contact with the fixed contacts 41 to 43 or a circumferential edge of the accommodating hole 21. On this occasion, the conductive parts 52a, 52b are switched to be engaged with the conductive engaging parts 41a to 43a and the interruptive engaging part 22 which are positioned at an opposite side to the operating direction. Moreover, the fixing part 53 is switched to be engaged with the supportive engaging parts 23 which are positioned at the opposite side to the operating direction.

In a state where the switch knob 3 is tilted to one side by the tilting operation, for example, the conductive part 52a, the fixing part 53, and the conductive part 52b are respectively in elastic contact with the conductive engaging part 41a, the supportive engaging part 23, and the conductive engaging part 42a, as shown in FIG. 6. Because the conductive part 52a and the conductive part 52b are respectively in elastic contact with the conductive engaging part 41a and the conductive engaging part 42a, electrical connection is established between the fixed contact 41 and the fixing contact 42, and thus, illumination in an ON mode is carried out.

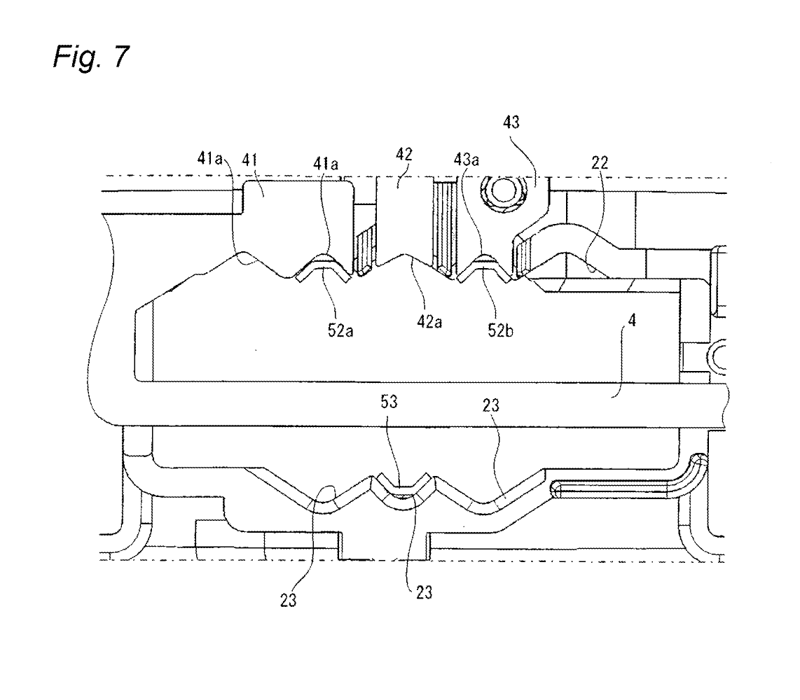

When the switch knob 3 is tilted to the other side, the conductive part 52a, the fixing part 53, and the conductive part 52b respectively come into elastic contact with the conductive engaging part 41a, the supportive engaging part 23, and the conductive engaging part 43a, as shown in FIG. 7. Because the conductive part 52a and the conductive part 52b respectively come into elastic contact with the conductive engaging part 41a and the conductive engaging part 43a, electrical connection is established between the fixed contact 41 and the fixed contact 43, and thus, illumination in a DOOR mode is carried out.

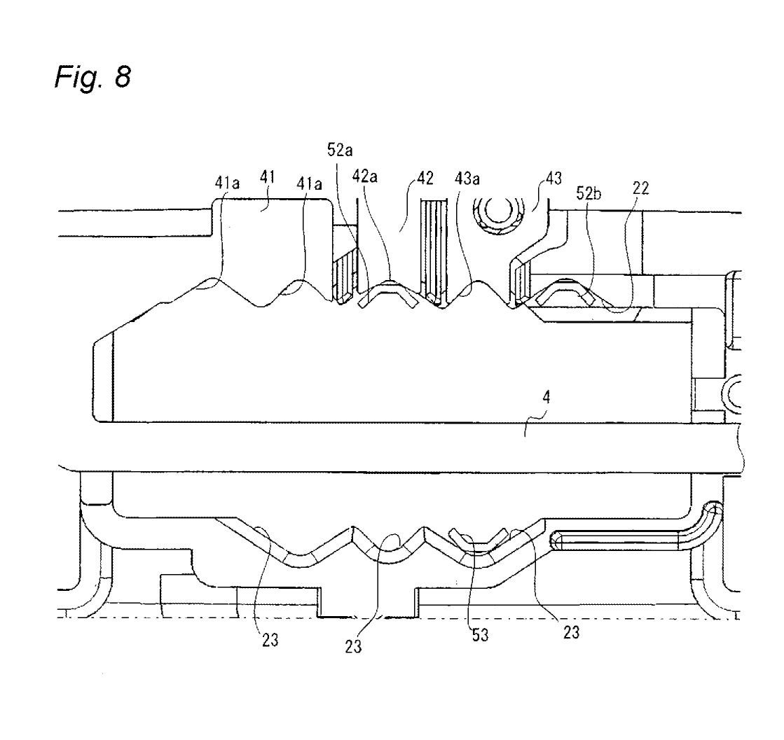

When the switch knob 3 is further tilted to the other side by the tilting operation, the conductive part 52a, the fixing part 53, and the conductive part 52b respectively come into elastic contact with the conductive engaging part 42a, the supportive engaging part 23, and the interruptive engaging part 22, as shown in FIG. 8. Because the conductive part 52a and the conductive part 52b respectively come into elastic contact with the conductive engaging part 42a and the interruptive engaging part 22, the fixed contacts 41 to 43 are not connected to one another, resulting in an OFF mode in which the illumination is not carried out.

According to this embodiment, the contact 5 is elastically supported by the two conductive parts 52a, 52b extending in the same direction, and the fixing part 53 whose end portion is positioned keeping distances from the end portions of the conductive parts 52a, 52b. Therefore, there is no necessity of providing the conductive engaging parts at both sides of the contact 5, and a space for installing the fixed contacts can be reduced. As the results, it is possible to reduce a space for installing the busbar 4 by the distance L between the one edge and the other edge of the accommodating hole 21 (See FIG. 6), as compared with a case where the fixed contact is also provided on the other edge of the accommodating hole 21. Accordingly, downsizing and weight reduction of the busbar 4 can be achieved. In addition, it is possible to change switch feeling (a touch of click) when the contact 5 is operated, only by altering the concave-convex shape of the fixed contacts 41 to 43, and the supportive engaging parts 23.

Moreover, according to the embodiment, because the fixing part 53 is positioned between the two conductive parts 52a, 52b, the contact 5 is prevented from being distorted. Therefore, it is possible to stabilize switching operations of the fixed contacts 41 to 43.

Moreover, according to the embodiment, the sum of the urging forces of the conductive parts 52a, 52b which are in contact with the fixed contacts 41 to 43 is equal to the urging force of the fixing part 53 which is in contact with the supportive engaging part 23. Therefore, contacts of the conductive parts 52a, 52b and the fixing part 53 can be achieved in a well balanced manner.

Moreover, according to the embodiment, the fixing part 53 has only to be elastically contacted with the supportive engaging parts 23 of the housing 2, but need not be contacted with the busbar 4. Therefore, the fixing part 53 can be made shorter than the conductive parts 52a, 52b so that the fixing part 53 may not protrude from the opening at the back side of the accommodating hole 21. As the results, it is possible to prevent the fixing part 53 from being deformed by getting in touch with a finger of an operator or the like.

Moreover, according to the embodiment, with such a simple structure that the conductive parts 52a, 52b and the fixing part 53 are provided on the contact 5, while the engaging parts to be engaged with these conductive parts 52a, 52b, and the fixing part 53 are provided on the housing 2 and the busbar 4, it is possible to give the switch feeling when the switch knob 3 is operated. As the results, the number of components of the illuminating device 1 can be reduced, and hence, reduction of the cost can be achieved.

Although a case where the single interruptive engaging part 22 is provided on the one edge of the accommodating hole 21 has been described in the above described embodiment, it is also possible to provide a plurality of the interruptive engaging parts 22, and to arrange the conductive engaging parts 41a to 43a corresponding to the respective interrupting engaging parts 22.

Moreover, structures of the conductive parts 52a, 52b and the fixing part 53 provided on the contact 5 are not limited to such structures as described in the embodiment. Besides, the shapes of the conductive engaging parts 41a to 43a, the interruptive engaging part 22, and the supportive engaging parts 23 can be optionally selected, provided that they can be engaged with the conductive parts 52a, 52b and the fixing part 53. For example, the conductive engaging parts 41a to 43a, the interruptive engaging part 22, and the supportive engaging parts 23 can be formed by providing projections on the busbar 4 and the accommodating hole 21.

The above-mentioned embodiment is merely a typical example of the present invention, and the present invention is not limited to the embodiment. That is, the present invention can be variously modified and implemented without departing from the essential features of the present invention.

According to the contact structure of the invention, the posture of the contact is stabilized.

What is claimed is:

1. A contact structure comprising:
a busbar, fixed to a housing, and provided with a plurality of fixed contacts, and
a contact, configured to be electrically connected to the fixed contacts, and including:
a body part fixed to a switch knob;
two conductive parts extended from the body part and configured to be brought into elastic contact with the fixed contacts; and
a fixing part, extended from the body part with space from respective end portions of the conductive parts, and configured to be brought into contact with a supportive engaging part of the housing so as to urge the conductive parts toward the fixed contacts,
wherein each of the fixed contacts respectively includes a concave portion configured to come into contact with the conductive parts, and convex portions formed at both sides of the concave portion,
wherein the fixed contacts are fixed in an electrically isolated manner from each other, and positioned only at a side of the conductive parts,
wherein the fixing part slides between a concave portion and convex portions which are formed in the supportive engaging part, and
wherein the conductive parts come into contact with the concave portions of the fixed contacts in a state where the fixing part is positioned in the concave portion of the supportive engaging part.

2. The contact structure according to claim 1, wherein
the fixing part is positioned between the two conductive parts.

3. The contact structure according to claim 1, wherein
a sum of urging forces of the conductive parts to come into contact with the fixed contacts is equal to an urging force of the fixing part to come into contact with the supportive engaging part.
